(19) United States
(12) Patent Application Publication
(10) Pub. No.: US 2021/0125201 A1
(43) Pub. Date: Apr. 29, 2021

(54) INFORMATION PROCESSING APPARATUS, INFORMATION PROCESSING METHOD, AND PROGRAM

(71) Applicant: Sony Corporation, Tokyo (JP)

(72) Inventors: Takahito MIGITA, Tokyo (JP); Katsutoshi KANAMORI, Tokyo (JP)

(73) Assignee: Sony Corporation, Tokyo (JP)

(21) Appl. No.: 17/051,886

(22) PCT Filed: May 24, 2019
(86) PCT No.: PCT/JP2019/020606

§ 371 Date: Oct. 30, 2020

(30) Foreign Application Priority Data
Jun. 8, 2018 (JP) 2018-110263

(51) Int. Cl. G06Q 30/02; G06Q 50/30; G06N 20/00; G06K 9/62

(52) U.S. Cl. CPC G06Q 30/0202; G06K 9/6218; G06N 20/00; G06Q 50/30

(57) ABSTRACT

The present technique relates to an information processing apparatus, an information processing method, and a program which enable a pick-up demand of a taxi to be learned and predicted in a more efficient manner.

An information processing apparatus includes: a control portion configured to divide a business region into a plurality areas and, using hired vehicle sequence data that is data for each area indicating that a business vehicle has picked up a customer, execute first clustering in which the plurality of areas are clustered using a first parameter and execute second clustering in which the plurality of areas are clustered using a second parameter. For example, the present technique can be applied to an information processing apparatus or the like that predicts a pick-up demand of a taxi.

### TECHNICAL FIELD

The present technique relates to an information processing apparatus, an information processing method, and a program and, particularly, to an information processing apparatus, an information processing method, and a program configured to be capable of learning and predicting a pick-up demand of a taxi in a more efficient manner.

### BACKGROUND ART

In the taxi industry, initiatives to predict a pick-up demand of a taxi and perform business in a more effective manner are being actively promoted (for example, refer to PTL 1).

### CITATION LIST

### Patent Literature

[PTL 1]

JP 2017-194863A

### SUMMARY

### Technical Problem

In a system that predicts demands for a taxi, an enormous amount of accumulated data is desirably learned and predicted in a more efficient manner.

The present technique has been devised in consideration of the situation described above and an object thereof is to enable a pick-up demand of a taxi to be learned and predicted in a more efficient manner.

### Solution to Problem

An information processing apparatus according to an aspect of the present technique includes: a control portion configured to divide a business region into a plurality areas and, using hired vehicle sequence data that is data for each area indicating that a business vehicle has picked up a customer, execute first clustering in which the plurality of areas are clustered using a first parameter and execute second clustering in which the plurality of areas are clustered using a second parameter.

An information processing method according to an aspect of the present technique includes: an information processing apparatus dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.

A program according to an aspect of the present technique causes a computer to execute processing for: dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.

In an aspect of the present technique, a business region is divided into a plurality areas and, using hired vehicle sequence data that is data for each area indicating that a business vehicle has picked up a customer, first clustering in which the plurality of areas are clustered using a first parameter is executed, and second clustering in which the plurality of areas are clustered using a second parameter is executed.

The program can be provided by being transmitted via a transmission medium or being recorded on a recording medium.

The information processing apparatus according to an aspect of the present technique can be realized by having a computer execute the program.

In addition, in order to realize the information processing apparatus according to an aspect of the present technique, the program to be executed by the computer can be provided by being transmitted via a transmission medium or being recorded on a recording medium.

The information processing apparatus may be an independent apparatus or an internal block that constitutes a single apparatus.

### Advantageous Effects of Invention

According to an aspect of the present technique, a pick-up demand of a taxi can be learned and predicted in a more efficient manner.

It should be noted that the advantageous effects described above are not necessarily restrictive and any of the advantageous effects described in the present disclosure may apply.

### BRIEF DESCRIPTION OF DRAWINGS

FIG. 1 is a block diagram showing a configuration example of an embodiment of a prediction system to which the present technique has been applied.

FIG. 2 is a diagram showing an example of a demand prediction screen of a demand prediction application.

FIG. 3 is a block diagram showing a configuration example of the prediction system.

FIG. 4 is a diagram showing an example of vehicle dynamic log data.

FIG. 5 is a diagram for explaining an example of generation of hired vehicle data.

FIG. 6 is a diagram showing an example of hired vehicle sequence data.

FIG. 7 is a flow chart for explaining hired vehicle sequence data generation processing.

FIG. 8 is a flow chart for explaining learning prediction processing.

FIG. 9 is a diagram showing an example of a result of first clustering.

FIG. 10 is a diagram showing an example of a result of the first clustering.

FIG. 11 is a diagram showing an example of a result of two-stage clustering.

FIG. 12 is a flow chart for explaining unknown area cluster classification processing.

FIG. 13 is a diagram showing a first display example of the demand prediction screen.

FIG. 14 is a diagram showing a second display example of the demand prediction screen.

FIG. 15 is a diagram showing a third display example of the demand prediction screen.

FIG. 16 is a diagram for explaining learning of a pick-up position.

FIG. 17 is a diagram showing a fourth display example of the demand prediction screen.

FIG. 18 is a diagram showing a fifth display example of the demand prediction screen.

FIG. 19 is a diagram showing a sixth display example of the demand prediction screen.

FIG. 20 is a diagram showing an example of a fare prediction screen.

FIG. 21 is a diagram for explaining learning of a pick-up position.

FIG. 22 is a diagram for explaining learning of a drop-off position.

FIG. 23 is a diagram for explaining learning of a pick-up position.

FIG. 24 is a block diagram showing a configuration example of an embodiment of a computer to which the present technique has been applied.

### DESCRIPTION OF EMBODIMENTS

Hereinafter, a mode (hereinafter, referred to as an embodiment) for implementing the present technique will be described. The description will be given in the following order.

1. Configuration example of prediction system
2. Example of screen of demand prediction application
3. Block diagram
4. Hired vehicle sequence data generation processing
5. Learning prediction processing
6. Unknown area cluster classification processing
7. Combined display of areas AR
8. Display of demand direction and frequency
9. Display of pinpoint prediction
10. Display of prediction of queueing time
11. Display of prediction of degree of long distance
12. Display of prediction of ride distance
13. Display of prediction of fare
14. Learning of pick-up position
15. Learning of drop-off position
16. Learning of pick-up position
17. Configuration example of computer

<1. Configuration Example of Prediction System>

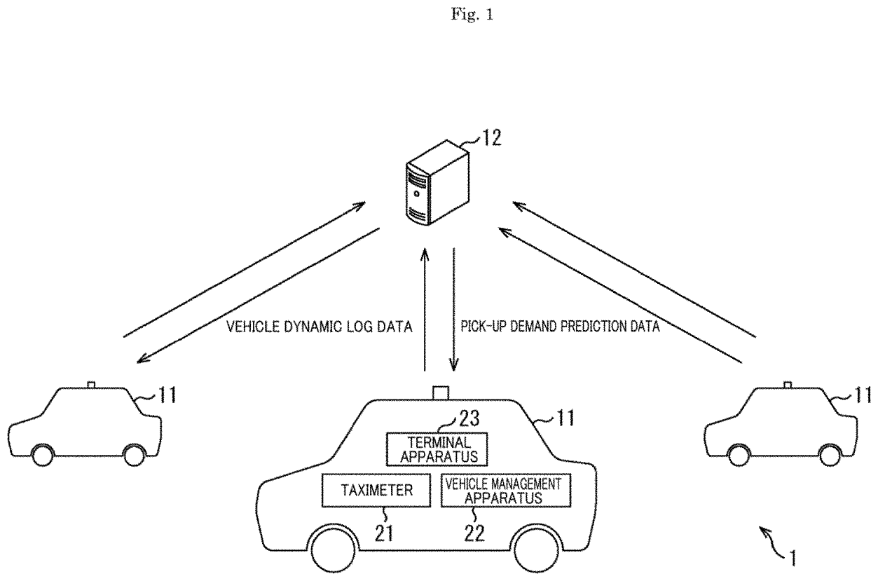

FIG. 1 shows a configuration example of an embodiment of a prediction system to which the present technique has been applied.

A prediction system 1 shown in FIG. 1 is a system which is constituted by a plurality of taxis 11 and a server (an information processing apparatus) 12 and which predicts a demand for pick-ups in a business region of the taxis 11 based on data acquired from the taxis 11.

The taxi 11 is a business vehicle that travels in a prescribed business region and picks up a passenger. The taxi 11 is mounted with a taximeter 21, a vehicle management apparatus 22, and a terminal apparatus 23.

The taximeter 21 accepts operations of “hired” and “for hire” by a driver. “Hired” represents a state where the taxi 11 has picked up a passenger and is traveling, and “for hire” represents a state the taxi 11 is traveling without picking up a passenger. When “hired”, the taximeter 21 calculates a fare (price of passage) in accordance with at least one of travel time and a travel distance and displays the fare on a prescribed display portion.

The vehicle management apparatus 22 generates vehicle dynamic log data that time-sequentially records positions (paths) traveled by the taxi 11, a status of “hired” or “for hire”, and the like at prescribed time intervals and transmits the generated vehicle dynamic log data to the server 12 via a prescribed network. The status of “hired” or “for hire” is acquired from the taximeter 21.

The terminal apparatus 23 is constituted by an information processing apparatus such as a smartphone or a tablet terminal. The terminal apparatus 23 stores an application program (hereinafter, also simply referred to as a demand prediction application) that displays a demand prediction of pick-ups on a display using pick-up demand prediction data transmitted from the server 12.

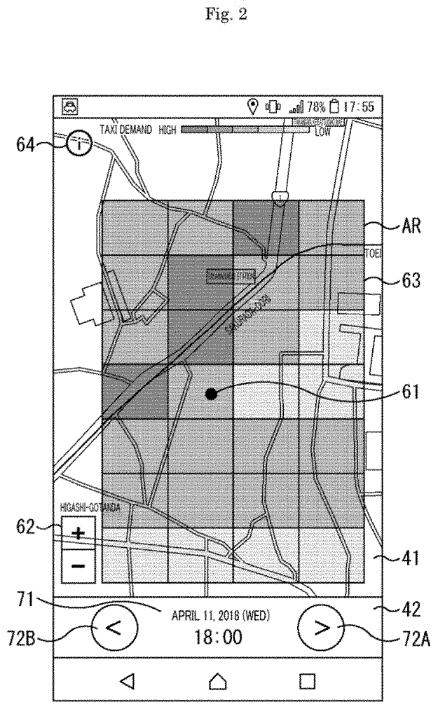

The demand prediction application is activated and executed on the terminal apparatus 23 by an operation performed by the driver. The demand prediction application receives pick-up demand prediction data transmitted from the server 12 via a prescribed network and, based on the received pick-up demand prediction data, displays a prediction result in which a pick-up demand is predicted on a map on a display. A specific display example of a prediction result that predicts a pick-up demand will be described later with reference to FIG. 2 and the like.

The server 12 acquires vehicle dynamic log data from a plurality of the taxis 11 via a network. In addition, using the large number of acquired pieces of vehicle dynamic log data, the server 12 generates pick-up demand prediction data and transmits the generated pick-up demand prediction data to each of the plurality of taxis 11 via the network.

The network that connects the server 12, the vehicle management apparatus 22, and the terminal apparatus 23 is constituted by, for example, a mobile communication network such as a so-called 3G or 4G network, the Internet, a public telephone network, a satellite communication network, or the like.

The driver of the taxi 11 drives the taxi 11 in order to acquire a passenger while referring to the pick-up demand prediction that is displayed on the display of the terminal apparatus 23 by the demand prediction application.

<2. Example of Screen of Demand Prediction Application>

FIG. 2 shows an example of the demand prediction screen that is displayed by the demand prediction application in the terminal apparatus 23.

On the demand prediction screen shown in FIG. 2, a map 41 is displayed and, at the same time, a current location symbol 61, a scaling button 62, a demand prediction mesh 63, a setting button 64, and the like are superimposed and displayed on the map 41.

In addition, the demand prediction screen is provided with a prediction time point setting region 42 in a region that differs from a display region of the map 41, and the prediction time point setting region 42 includes a prediction time point display 71 and prediction time point change buttons 72A and 72B.

The current location symbol 61 represents a current location of the taxi 11. The scaling button 62 is operated when enlarging or reducing a scale of the map 41.

The demand prediction mesh 63 is constituted by a plurality of areas AR being arranged in a matrix pattern. An area AR represents a single region created by dividing the demand prediction mesh 63 in a grid-like manner. While 28 (4 times 7) areas AR are arranged in a partial region of the map 41 in the example shown in FIG. 2, the areas AR may be superimposed and displayed on an entire region of the map 41.

Each area AR of the demand prediction mesh 63 is displayed in a color or density in accordance with a degree of a pick-up demand based on the pick-up demand prediction data transmitted from the server 12. For example, in FIG. 2, an area AR with high density represents an area AR with a high pick-up demand and an area AR with low density represents an area AR with a low pick-up demand.

The setting button 64 is operated when configuring various settings related to display of the demand prediction screen such as selecting items that are displayable on the demand prediction screen and an order of display. Details of each item that is displayable on the demand prediction screen will be described later.

The prediction time point display 71 in the prediction time point setting region 42 displays a time point of demand prediction that is being displayed by the demand prediction mesh 63. In other words, a demand prediction at a time point displayed in the prediction time point display 71 is displayed on the demand prediction mesh 63. Tapping the prediction time point display 71 resets the prediction time point display 71 to a present time point. The prediction time point change buttons 72A and 72B are operated when advancing or reversing the prediction time point of the prediction time point display 71 by prescribed units (for example, 10 minutes).

As described above, the demand prediction application of the terminal apparatus 23 receives pick-up demand prediction data transmitted from the server 12 and, based on the received pick-up demand prediction data, displays the demand prediction mesh 63 that predicts a pick-up demand on the map 41 as a prediction result on a display.

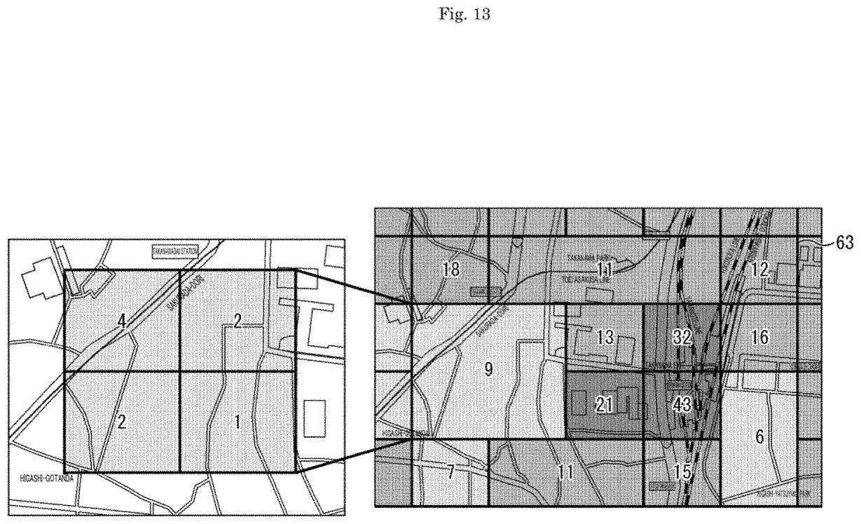

While each area AR of the demand prediction mesh 63 is to be displayed in a different color or density in accordance with a degree of a pick-up demand in the example shown in FIG. 2, as shown in FIG. 13 to be described later, a prediction result of the number of pick-ups can be displayed at the same time.

<3. Block Diagram>

Next, detailed configurations of each apparatus mounted to the taxi 11 and the server 12 will be described.

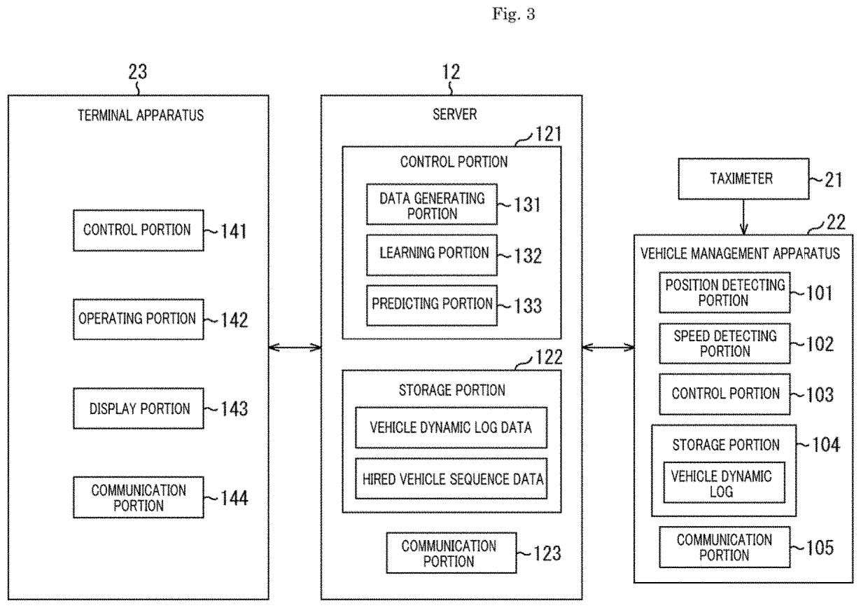

FIG. 3 is a block diagram showing configuration examples of the server 12, the taximeter 21, the vehicle management apparatus 22, and the terminal apparatus 23.

The taximeter 21 accepts operations of “hired” and “for hire” by the driver and displays a status of “hired” or “for hire” and a fare (price of passage) on a prescribed display portion. The taximeter 21 supplies the vehicle management apparatus 22 with the status of “hired” or “for hire”.

The vehicle management apparatus 22 includes a position detecting portion 101, a speed detecting portion 102, a control portion 103, a storage portion 104, and a communication portion 105.

For example, the position detecting portion 101 is constituted by a GPS (Global Positioning System) receiver or the like and receives a positioning signal broadcast by a positioning satellite to detect a current position of the taxi 11. In addition, the position detecting portion 101 includes a gyroscope sensor, a geomagnetic sensor, or the like and detects a travel direction of the taxi 11.

The speed detecting portion 102 is constituted by a speed sensor, an acceleration sensor, or the like and detects a movement speed of the taxi 11. Alternatively, the speed detecting portion 102 may detect the movement speed of the taxi 11 by acquiring a measurement value from a speed sensor that detects a revolution speed of a wheel of the taxi 11.

For example, the control portion 103 is constituted by a CPU (Central Processing Unit), a RAM (Random Access Memory), and the like, reads an operation control program stored in the storage portion 104, and controls operations of the entire vehicle management apparatus 22 in accordance with the operation control program. Specifically, the control portion 103 acquires data at constant time intervals from each of the taximeter 21, the position detecting portion 101, and the speed detecting portion 102, generates vehicle dynamic log data, and causes the storage portion 104 to store the generated vehicle dynamic log data. In addition, at a prescribed timing set in advance, the control portion 103 regularly or irregularly transmits the vehicle dynamic log data stored in the storage portion 104 to the server 12 via the communication portion 105.

For example, the storage portion 104 is constituted by a hard disk, a ROM (Read Only Memory), a RAM, an NVRAM (Non Volatile RAM), and the like and stores vehicle dynamic log data. The communication portion 105 performs prescribed communication with the server 12 under the control of the control portion 103. The communication portion 105 is constituted by a network interface that performs network communication via a prescribed network.

The server 12 includes a control portion 121, a storage portion 122, and a communication portion 123.

For example, the control portion 121 is constituted by a CPU, a RAM, and the like, reads an operation control program stored in the storage portion 122, and controls operations of the entire server 12 in accordance with the operation control program.

Functionally, the control portion 121 at least includes a data generating portion 131, a learning portion 132, and a predicting portion 133 and predicts a pick-up demand for each area AR on the map 41 by machine learning. As a method of machine learning, an arbitrary method can be selected such as the k-means method, a self-organizing map (SOM), a neural network, or an HMM (hidden Markov model).

The data generating portion 131 causes the storage portion 122 to store vehicle dynamic log data acquired from each vehicle management apparatus 22 of a plurality of taxis 11 via the communication portion 123.

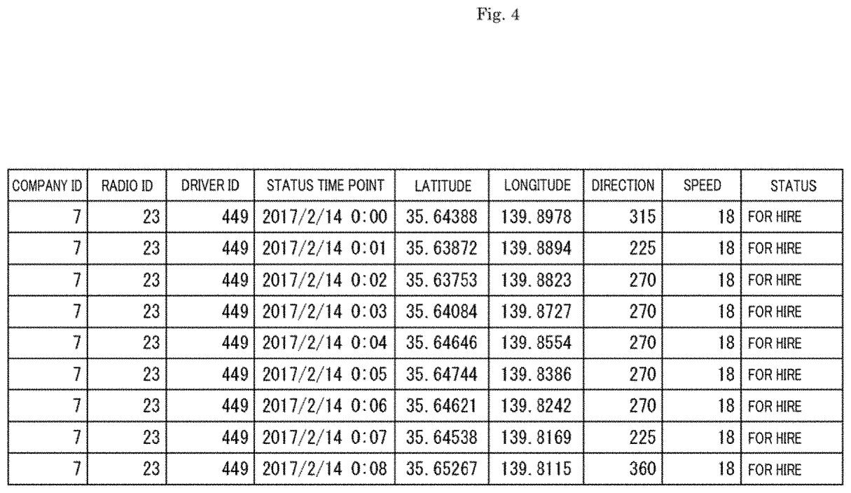

FIG. 4 shows an example of vehicle dynamic log data which is generated by the vehicle management apparatus 22 of the taxi 11 and which is transmitted to the server 12.

The vehicle management apparatus 22 generates vehicle dynamic log data at prescribed time intervals (for example, 1-minute intervals) and accumulates the vehicle dynamic log data.

As shown in FIG. 4, items to be generated as vehicle dynamic log data include: a company ID for identifying a company to which the taxi 11 belongs; a radio ID for identifying a vehicle of the taxi 11; a driver ID for identifying a driver who is driving the taxi 11; a status time point that represents a generation time point of a status; a latitude and a longitude that represent positional information of the taxi 11; a direction and a speed that represent a travel speed and a travel direction of the taxi 11; and a status of “hired” or “for hire”.

The data generating portion 131 generates hired vehicle data that is data related to a hired vehicle from the vehicle dynamic log data stored in the storage portion 122.

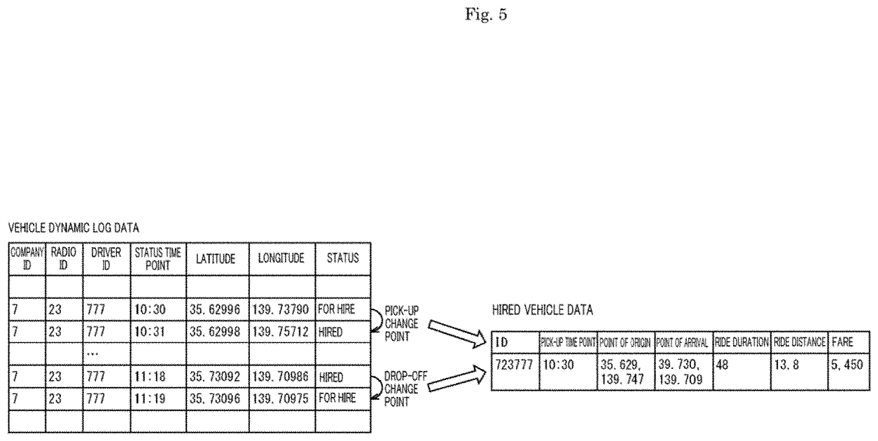

FIG. 5 shows an example of generation of hired vehicle data.

The hired vehicle data is data which is obtained by extracting information related to a pick-up made by the taxi 11 from vehicle dynamic log data and which is generated from information on a pick-up change point at which the status changes from “for hire” to “hired” and a drop-off change point at which the status changes from “hired” to “for hire”.

For example, as shown in FIG. 5, the hired vehicle data includes respective items of an ID, a pick-up time point, a point of origin, a point of arrival, a ride duration, a ride distance, and a fare.

The ID is data that combines the company ID, the radio ID, and the driver ID in vehicle dynamic log data.

As the pick-up time point, a time point between the status time point of “for hire” and the status time point of “hired” of the pick-up change point is calculated and recorded.

As the point of origin, a latitude and a longitude between a latitude and a longitude of “for hire” and a latitude and a longitude of “hired” of the pick-up change point is calculated and recorded.

As the point of arrival, a latitude and a longitude between a latitude and a longitude of “for hire” and a latitude and a longitude of “hired” of the drop-off change point is calculated and recorded.

As the ride duration, a period of time (in units of, for example, minutes) between the status time point of “for hire” and the status time point of “hired” of the drop-off change point from the pick-up time point is calculated and recorded.

As the ride distance, a distance (in units of, for example, km) from the point of origin to the point of arrival is calculated and recorded.

The fare is calculated in accordance with provisions on taxi fares from the ride duration and the ride distance and the calculated fare is recorded.

The calculation methods of the respective items of hired vehicle data are not limited to the methods described above and other methods may be adopted. For example, the respective items described above may be calculated from first and last pieces of vehicle dynamic log data of which the status is “hired”. In addition, information on the fare and the ride distance may be acquired from the vehicle management apparatus 22 as a part of the vehicle dynamic log data instead of being calculated from positions of the pick-up change point and the drop-off change point.

Based on the large number of pieces of hired vehicle data generated from the vehicle dynamic log data of the vehicle management apparatuses 22 of the large number of taxis 11, the data generating portion 131 generates, for each area AR, hired vehicle sequence data that is time-sequential data representing the number of pick-ups in prescribed time units (10 minutes). For example, the data generating portion 131 generates, for each area AR, hired vehicle sequence data that is time-sequential data representing a count of the number of pick-ups for every 10 minutes.

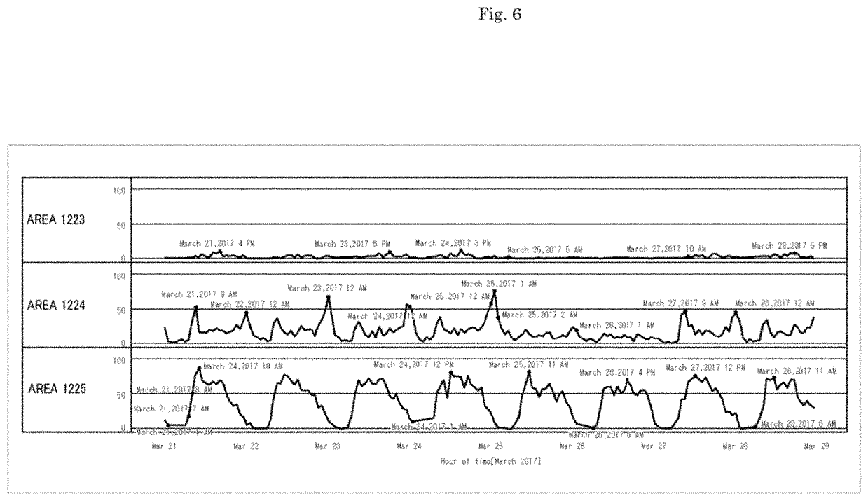

FIG. 6 shows an example of hired vehicle sequence data of three areas AR, namely, an area 1223, an area 1224, and an area 1225 among the plurality of areas AR obtained by dividing the business region of the taxi 11.

An abscissa of the hired vehicle sequence data represents a date and time and an ordinate thereof represents the number of pick-ups. While the hired vehicle sequence data shown in FIG. 6 is eight days' worth of data, a creation period of hired vehicle sequence data can be set to an arbitrary period such as one week, one month, or one year. For example, setting the creation period of hired vehicle sequence data to one week enables a variation by day of the week to be captured, and setting the creation period of hired vehicle sequence data to a long period such as several months or one year enables seasonal variations such as the year-end and New Year holidays, the Golden Week vacation (a collection of public holidays on the Japanese calendar), and summer vacation to be captured in addition to a variation by day of the week.

In the example of the hired vehicle sequence data of the area 1223, for example, the number of pieces of hired vehicle data of which the pick-up time point is included in the 10 minutes from 10:00 to 10:10 on Mar. 21, 2017 and of which the point of origin is located within the area 1223 is counted as the number of pick-ups. The count result is adopted as the hired vehicle sequence data of the area 1223 from 10:00 to 10:10 on Mar. 21, 2017. Similar processing is calculated in an entire period of the acquired hired vehicle data to generate the hired vehicle sequence data of the area 1223.

Returning to FIG. 3, using the large number of pieces of hired vehicle sequence data of a long period generated based on the hired vehicle data acquired from the vehicle management apparatuses 22 of the large number of taxis 11, the learning portion 132 generates, by learning, a predictor for predicting a pick-up demand.

The predicting portion 133 predicts a pick-up demand at a prescribed time point or in a prescribed time slot using the predictor generated by the learning portion 132. A prediction result of the predicting portion 133 is transmitted to the terminal apparatus 23 as pick-up demand prediction data.

The storage portion 122 stores the vehicle dynamic log data acquired from each of the vehicle management apparatuses 22 and the hired vehicle sequence data generated from the vehicle dynamic log data. The hired vehicle data which is intermediate data for generating the hired vehicle sequence data from the vehicle dynamic log data may also be stored in the storage portion 122.

The communication portion 123 performs prescribed communication with the vehicle management apparatus 22 and the terminal apparatus 23 under the control of the control portion 121. The communication portion 123 is constituted by a network interface that performs network communication via a prescribed network.

The terminal apparatus 23 includes a control portion 141, an operating portion 142, a display portion 143, and a communication portion 144.

For example, the control portion 141 is constituted by a CPU, a RAM, and the like and controls operations of the entire terminal apparatus 23 in accordance with an operation control program that is stored in a storage portion (not illustrated). For example, the control portion 141 executes a demand prediction application based on an operation by the driver who is a user.

The operating portion 142 is constituted by a plurality of operation buttons provided on the terminal apparatus 23, a touch panel superimposed on the display portion 143, and the like and accepts an operation by the user and supplies the control portion 141 with an operation signal that corresponds to the accepted operation.

For example, the display portion 143 is constituted by an LCD (Liquid Crystal Display) and displays prescribed information such as the demand prediction screen shown in FIG. 2.

The communication portion 144 performs prescribed communication with the server 12 under the control of the control portion 141. The communication portion 144 is constituted by a network interface that performs network communication via a prescribed network.

The server 12, the taximeter 21, the vehicle management apparatus 22, and the terminal apparatus 23 are configured as described above.

Hereinafter, details of processing respectively executed by the server 12, the vehicle management apparatus 22, and the terminal apparatus 23 will be described.

<4. Hired Vehicle Sequence Data Generation Processing>

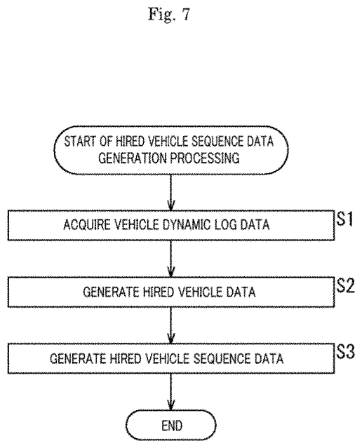

First, hired vehicle sequence data generation processing by the server 12 will be described with reference to the flow chart shown in FIG. 7. For example, the processing can be executed at a prescribed timing such as regularly or irregularly

First, in step S1, the data generating portion 131 of the server 12 acquires (receives) vehicle dynamic log data transmitted via the network from each of the vehicle management apparatuses 22 of the plurality of taxis 11. It should be noted that each vehicle management apparatus 22 can individually transmit the vehicle dynamic log data to the server 12 at an arbitrary timing and the transmission need not be concurrent.

In step S2, the data generating portion 131 generates hired vehicle data from the acquired pieces of vehicle dynamic log data. For example, the hired vehicle data includes data calculated from items of the vehicle dynamic log data such as a pick-up time point and a point of origin as well as external data added by the server 12 such as a fare. Other examples of external data that can be provided include date-related information that is related to a date such as a day of the week, a weekday, or a holiday, event information that is related to an event or the like held on the day of data acquisition in a relevant area AR, and information on weather. Adding external data as hired vehicle data enables, for example, a state-specific pick-up demand in accordance with each day of the week, a presence or absence of an event, the weather, or the like to be learned and predicted.

In step S3, based on the large number of pieces of hired vehicle data generated from the vehicle management apparatuses 22 of the large number of taxis 11, the data generating portion 131 generates hired vehicle sequence data for each area AR, stores the generated hired vehicle sequence data in the storage portion 122, and ends the hired vehicle sequence data generation processing.

<5. Learning Prediction Processing>

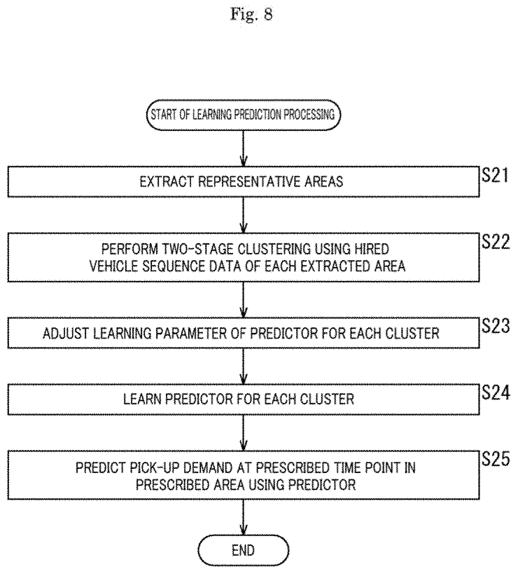

Next, referring to the flow chart in FIG. 8, learning prediction processing for learning and predicting a pick-up demand using the generated hired vehicle sequence data for each area AR will be described. For example, the processing can also be executed at a prescribed timing such as regularly or irregularly.

First, in step S21, the learning portion 132 of the server 12 extracts representative areas from the plurality of areas AR obtained by dividing the business region of the taxis 11. The learning portion 132 selects areas AR in a prescribed number determined in advance from the plurality of areas AR as representative areas. The representative areas may be randomly determined or, for example, a knowledgeable user may select representative areas according to a prescribed criterion such as inner-city areas AR and suburban areas AR, areas AR near a station and areas AR far from a station, or areas AR with a large number of stations and areas AR with a small number of stations.

In step S22, the learning portion 132 performs two-stage clustering using hired vehicle sequence data of each of the areas AR extracted as representative areas. More specifically, the learning portion 132 executes first clustering in which each of the extracted plurality of areas AR is clustered using a first parameter and second clustering in which each of the extracted plurality of areas AR is clustered using a second parameter.

For example, the learning portion 132 executes the first clustering using an average and a dispersion of the number of pick-ups per unit time (for example, per day) in an area AR as the first parameter and executes the second clustering using a waveform of an average number of pick-ups per unit time (for example, per day) in the area AR as the second parameter. As a method of clustering, for example, the k-means method or the like can be used.

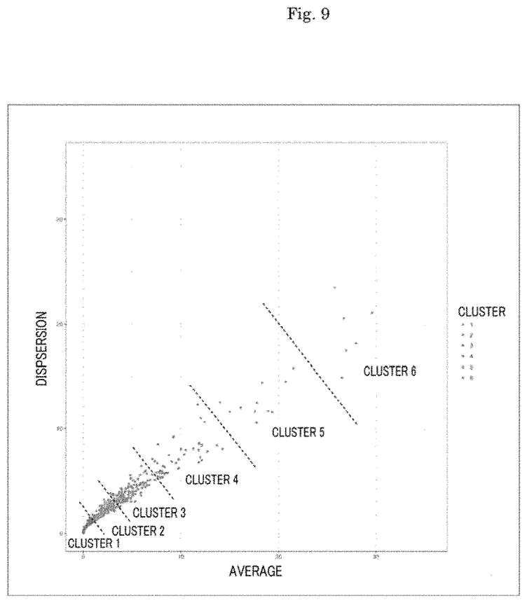

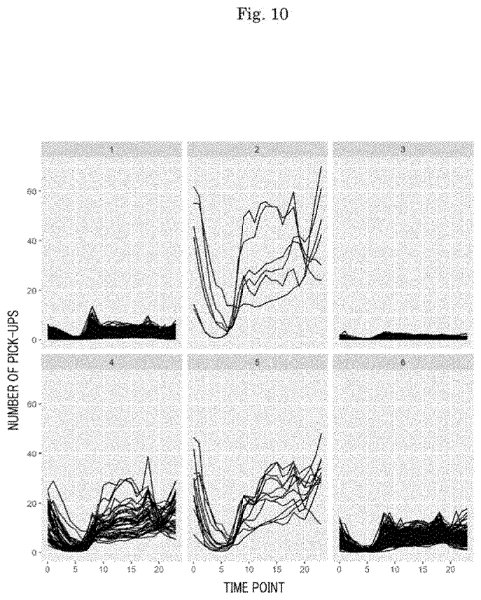

FIGS. 9 and 10 show an example of a result of the first clustering for clustering a plurality of areas AR that are representative areas using an average and a dispersion of the number of pick-ups as a parameter.

FIG. 9 shows a distribution of the plurality of areas AR extracted as representative areas, with an abscissa representing an average and an ordinate representing a dispersion.

FIG. 10 is a diagram showing hired vehicle sequence data of the plurality of areas AR that are representative areas for each cluster. In FIG. 10, an abscissa represents a time point (0:00 to 24:00) and an ordinate represents the number of pick-ups.

Basically, since a similar feature appears in the hired vehicle sequence data for each of the respective time slots (morning, daytime, nighttime, and the like) of a day, the clustering is performed using data obtained by dividing the hired vehicle sequence data into basic units (day).

In FIGS. 9 and 10, (hired vehicle sequence data of) a plurality of areas AR extracted as representative areas are classified into six clusters.

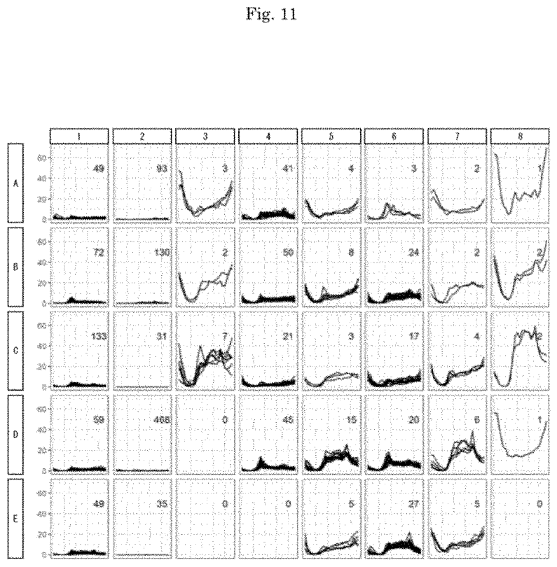

FIG. 11 shows an example of a result of two-stage clustering which organizes a clustering result of the first clustering and a clustering result of the second clustering.

In FIG. 11, a horizontal direction (units of columns) represents the clustering result of a first stage and a vertical direction (units of rows) represents the clustering result of a second stage. Abscissas and ordinates of the respective graphs arranged in a matrix pattern are similar to those in FIG. 10.

In FIG. 11, a column number 1, a column number 2, a column number 3, . . . are the clustering result by the first clustering and represent a set of areas AR (a group of areas AR) in which a plurality of areas AR arranged in a vertical direction have similar averages and dispersions of the number of pick-ups. On the other hand, a row number A, a row number B, a row number C, . . . are the clustering result by the second clustering and represent a result of further clustering, in areas AR with similar waveforms of the average number of pick-ups, respective groups of areas AR that represent the clustering result of the first clustering. A numeral in each of the graphs arranged in a matrix pattern represents the number of areas AR classified into the cluster. For example, the numeral “468” in a graph of a cluster D-2 with a row number of D and a column number of 2 represents that 468 areas AR among the representative areas have been classified into the cluster D-2. The average and the dispersion of the number of pick-ups per unit time having been used as the first parameter represent a magnitude of the number of pick-ups per unit time and a magnitude of a variation in the number of pick-ups in the unit time, and the waveform of the average number of pick-ups per unit time having been used as the second parameter represents a trend in a variation over time of the number of pick-ups in the unit time.

It should be noted that the clustering of the second stage may be individually executed for each clustering result of the first stage or may be executed for all of the plurality of areas AR extracted as representative areas independent of the clustering results of the first stage.

In the present embodiment, for example, it is assumed that the business region of the taxis 11 are divided into 4400 areas AR, among the 4400 areas AR, half or 2200 areas AR are extracted as representative meshes, and two-stage clustering is performed with respect to the 2200 areas AR to classify the areas AR into 44 clusters.

Next, in step S23 in FIG. 8, the learning portion 132 adjusts, for each cluster, a learning parameter of a predictor that is typified by a learning rate using hired vehicle sequence data belonging to the cluster and advances to step S24.

In step S24, the learning portion 132 learns, for each cluster, the predictor for predicting a pick-up demand using the adjusted learning parameter and the hired vehicle sequence data of one or more areas AR belonging to the cluster, and advances to step S25.

In step S25, the predicting portion 133 predicts a pick-up demand at a prescribed time point in a prescribed area AR using the predictor generated by the learning portion 132. For example, when predicting a pick-up demand of areas AR belonging to a cluster C-4, a pick-up demand of a prescribed time point is predicted using a predictor of the cluster C-4.

The learning processing of steps S21 to S24 and the prediction processing of step S25 may be executed as a continuous series of processing or the prediction processing of step S25 may be executed at a different timing to the processing of steps S21 to S24.

For example, the processing of step S25 is executed following the processing of step S24 and the pick-up demand at a prescribed time point of each area AR constituting the business region of the taxis 11 is calculated and stored in the storage portion 122. In addition, in response to a request from the terminal apparatus 23, prediction data of a demand that is stored in the storage portion 122 is transmitted to the terminal apparatus 23 as pick-up demand prediction data.

Alternatively, the processing of step S25 is executed at a timing where prediction data of a pick-up demand at a prescribed time point of one or more areas AR is requested from terminal apparatus 23, and a processing result of step S25 is transmitted to the terminal apparatus 23 as pick-up demand prediction data.

As shown in FIG. 2, the demand prediction application of the terminal apparatus 23 having received the pick-up demand prediction data displays the demand prediction mesh 63 of which a color or a density is changed in accordance with the number of pick-ups of each area AR that is a prediction result.

According to the learning prediction processing described above, among the 4400 areas AR that constitute the business region, each of the 2200 areas AR extracted as representative areas is classified into a prescribed cluster, and a pick-up demand can be predicted in accordance with a classification result.

On the other hand, with respect to the remaining 2200 areas AR (hereinafter, also referred to as unknown areas AR) not having been extracted as representative areas, at this stage, it is unclear into which cluster the areas AR are to be classified and a pick-up demand cannot be predicted.

<6. Unknown Area Cluster Classification Processing>

Next, processing for predicting a pick-up demand of an unknown area AR will be described.

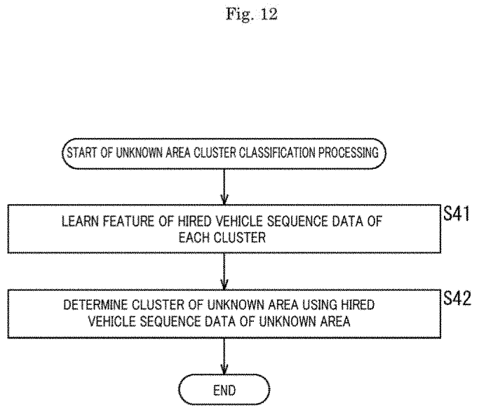

Unknown area cluster classification processing for determining a cluster to which an unknown area AR belongs will be explained with reference to the flow chart in FIG. 12. For example, the processing can be executed at a prescribed timing such as regularly or irregularly

First, in step S41, the learning portion 132 of the server 12 learns a feature (an average, a dispersion, or a shape) of hired vehicle sequence data of each cluster having been classified in the learning prediction processing. In other words, a relationship between the hired vehicle sequence data of the 2200 areas AR extracted as representative areas and clusters is learned by a learner.

In step S42, the predicting portion 133 of the server 12 inputs hired vehicle sequence data of an unknown area AR into a classifier that uses the parameter obtained by the learning in step S41 to determine a cluster of the unknown area AR.

As described above, according to the unknown area cluster classification processing, clustering of unknown areas AR other than representative areas can be executed using a classifier generated by learning a relationship between clustering results of the representative areas and pieces of hired vehicle sequence data.

Once the cluster of an unknown area AR can be determined, a pick-up demand for the unknown area AR can be predicted by executing the prediction processing of step S25 described above using a predictor of the determined cluster.

Therefore, by executing both the learning prediction processing shown in FIG. 8 and the unknown area cluster classification processing shown in FIG. 12, a pick-up demand of all of the 4400 areas AR that constitute the business region of the taxis 11 can be predicted.

In the learning prediction processing shown in FIG. 8, since the number of areas AR to be learned or, in other words, a data amount of hired vehicle sequence data can be reduced by extracting representative areas which is the processing in step S21, a calculation load can be reduced and a cost and a time required by pick-up demand prediction can be reduced.

In addition, in step S22, by performing two-stage clustering using hired vehicle sequence data of each of the areas AR extracted as representative areas, the number of learners can be reduced and the cost and the time required by pick-up demand prediction can be reduced. Specifically, while learners in the number of (2200) areas AR extracted as representative areas are required when the two-stage clustering is not performed, performing the two-stage clustering and having been able to classify the areas AR into a prescribed number of clusters enables the number of learners necessary for learning to be reduced to the number of (44) clusters.

The learner of each cluster can use the hired vehicle sequence data of all of the areas AR classified into the cluster. In other words, for example, when learning a pick-up demand prediction of the area 1223, generally, learning is performed using only the hired vehicle sequence data acquired in the area 1223. In contrast, in the present technique, for example, when the area 1223 is classified into a cluster D-2 and there are 468 areas AR belonging to the cluster D-2, learning can be performed using hired vehicle sequence data of the 468 areas AR including areas AR other than the area 1223. Therefore, since learning can be performed with respect to one learner using a larger amount of data than an amount of data that can be acquired in a single area AR, prediction accuracy can be improved.

In addition, even with respect to an unknown area AR that is not extracted as a representative area in the learning prediction processing, performing unknown area cluster classification processing enables a cluster of the unknown area AR to be determined and a pick-up demand of the unknown area AR to be predicted using a predictor of the cluster that has been determined.

While adjustment of a learning parameter and learning of a predictor are performed using only the hired vehicle sequence data of each of the areas AR extracted as representative areas in steps S23 and S24 described above, alternatively, the adjustment of the learning parameter and the learning of the predictor may be performed by additionally using the hired vehicle sequence data of all unknown areas AR included in the business region once clusters have been determined with respect to the unknown areas AR.

Therefore, according to the prediction system 1 shown in FIG. 1, learning and predictions can be performed more efficiently. In addition, prediction accuracy can be improved with a small amount of data.

In the learning prediction processing and the unknown area cluster classification processing described above, cluster classification and learning are performed using hired vehicle sequence data generated from all of the pieces of vehicle dynamic log data acquired from the vehicle management apparatuses 22 of a plurality of taxis 11 irrespective of a day of the week, a weekday, a holiday, or the like.

However, hired vehicle sequence data may be classified into categories such as a day of the week, a weekday, a holiday, weather, or the like and cluster classification and learning may be performed for each category. Accordingly, a pick-up demand can be predicted for each prescribed condition such as a day of the week, a weekday, a holiday, weather, a presence or an absence of an event, or the like and a prediction result thereof can be displayed on a display.

<7. Combined Display of Areas AR>

Hereinafter, various display examples with respect to the demand prediction application of the terminal apparatus 23 displaying a prediction result of a pick-up demand on a display will be explained.

FIG. 13 shows a first display example of the demand prediction screen that is displayed by the demand prediction application.

On the demand prediction screen shown in FIG. 2, the demand prediction mesh 63 is constituted by arranging areas AR with a same rectangular size in a matrix pattern. In addition, the number of pick-ups of each area AR which represents a prediction result is not displayed on the screen.

In contrast, in the demand prediction mesh 63 shown in FIG. 13, the number of pick-ups of each area AR which represents a prediction result is displayed in the area AR.

In addition, with respect to a plurality of areas AR of which the number of pick-ups of a plurality of adjacent areas AR is equal to or smaller than a prescribed threshold, the number of pick-ups is displayed by combining the plurality of areas AR into a single area AR. In the first display example shown in FIG. 13, a plurality of areas AR of which the number of pick-ups of a plurality of adjacent areas AR is equal to or smaller than 10 is combined and displayed as a single area AR. Specifically, 2×2 areas AR of which the numbers of pick-ups when displayed in a same rectangular size are “4”, “2”, “2”, and “1” are combined into a single area AR and displayed as “9”. It is needless to say that, there are cases where, depending on the number of adjacent pick-ups, areas AR are not combined even when the number of pick-ups of a plurality of adjacent areas AR is equal to or smaller than 10.

Since guessing a demand is difficult when the predicted number of pick-ups is small such as when 0, 1, or 2, the demand prediction application can display a demand prediction in units of areas AR of which the number of pick-ups is equal to or larger than a certain value. Accordingly, accuracy of prediction can be improved and a driver can be provided with more useful information.

It should be noted that the number of pick-ups to be displayed as a prediction result may be a value given a certain leeway such as “10 to 13”.

<8. Display of Demand Direction and Frequency>

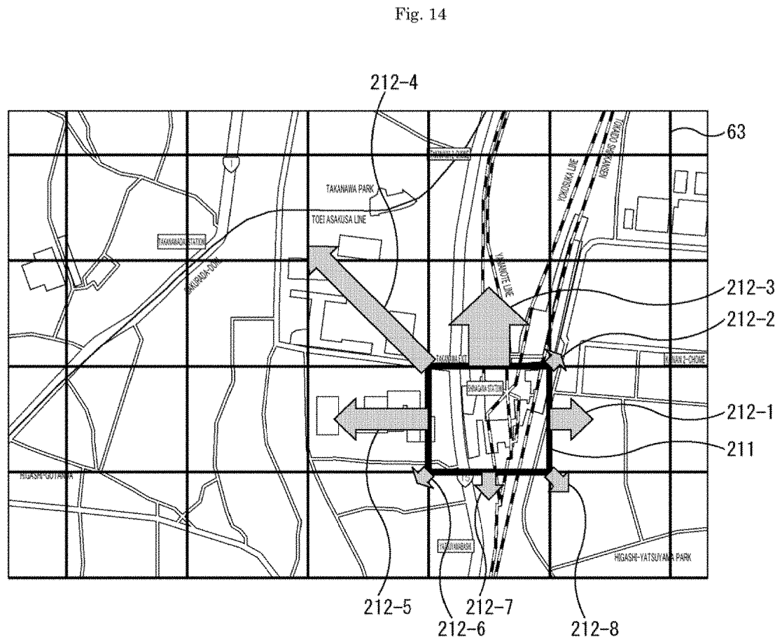

FIG. 14 shows a second display example of the demand prediction screen that is displayed by the demand prediction application.

In FIG. 14, display of a color or a density in accordance with a degree of a pick-up demand of each area AR has been omitted.

FIG. 14 shows a display example of displaying a further detailed prediction result with respect to an area AR (hereinafter, referred to as an area AR of attention) that attracts attention from the driver among the respective areas AR of the demand prediction mesh 63 that is superimposed and displayed on the map 41.

When the driver performs an operation to designate the area AR of attention such as tapping (touching) a prescribed area AR among the respective areas AR of the demand prediction mesh 63 that is superimposed and displayed on the map 41, the demand prediction application performs display such as that shown in FIG. 14 with respect to the designated area AR of attention.

In FIG. 14, with respect to the area AR of attention designated by the driver, an area-of-attention frame 211 that is a wider frame than other areas AR is displayed. In addition, arrows 212-1 to 212-8 that point outward from the area-of-attention frame 211 are displayed. When each of the arrows 212-1 to 212-8 is not particularly distinguished from one another, the arrows 212-1 to 212-8 will be simply referred to as an arrow 212.

A direction of the arrow 212 represents a movement direction of passengers who are picked up in the area AR of attention and a length of the arrow 212 represents an average movement distance of passengers who are picked up in the area AR of attention and who move in the direction of the arrow 212. In addition, a width of the arrow 212 (a thickness in a direction perpendicular to the direction of the arrow) represents a ratio of pick-ups in the direction indicated by the arrow 212 to all directions.

Therefore, the example shown in FIG. 14 shows that, among passengers who are picked up in the area AR of attention, there is a large number of passengers who move in the direction of the arrow 212-3 in terms of ratios of pick-ups and passengers who move in the direction of the arrow 212-4 do so over a long movement distance. In addition, for example, it is shown that, among passengers who are picked up in the area AR of attention, there are only a few passengers who move in the directions of the arrows 212-2 and 212-6 and movement distances of such passengers are short.

For example, when determining an area AR to perform so-called “cruising” (looking for a passenger while driving the taxi 11), the driver can set a prescribed area AR of the demand prediction mesh 63 as an area AR of attention, search for an area AR with a large number of passengers whose direction is the same direction in which the driver is returning by displaying the arrow 212, and the like.

A movement direction of passengers in each area AR can be predicted by learning that also includes information on directions (travel directions) of vehicle dynamic log data.

It should be noted that the number of arrows 212 to be displayed or, in other words, the number of predictions of the movement direction of passengers may be any number other than 8 shown in FIG. 14. In addition, the ratio of passengers moving in the direction of the arrow 212 to all directions may be represented by a method other than a representation by a width of an arrow such as the use of a different color or numerical notation.

<9. Display of Pinpoint Prediction>

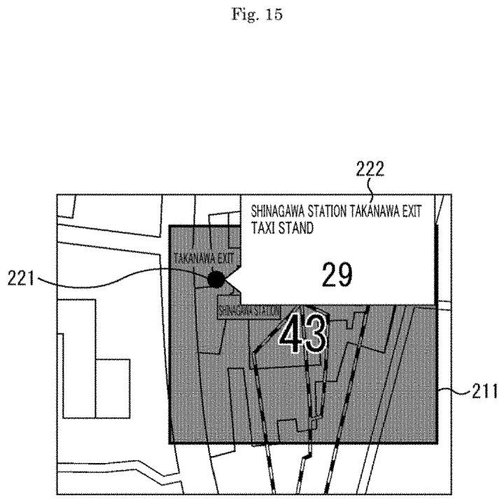

FIG. 15 shows a third display example of the demand prediction screen that is displayed by the demand prediction application.

FIG. 15 also shows a display example of displaying a further detailed prediction result when the driver selects a prescribed area AR as the area AR of attention.

For example, areas AR created by dividing the business region into prescribed units may include locations which have a fixed pick-up position and which have a larger number of pick-ups than other locations such as a taxi stand in front of a station, a taxi stand in front of a hotel, and the like.

When such a pick-up position with a large number of pick-ups is present in the area AR of attention, the demand prediction application can make a pinpoint prediction of a pick-up position with a large number of pick-ups and the number of pick-ups at the pick-up position and display the pick-up position and the number of pick-ups separately from the number of pick-ups in the entire area AR of attention. Hereinafter, a pick-up position with a large number of pick-ups which is specified in the area AR of attention will be referred to as a pinpoint pick-up position.

In FIG. 15, a pinpoint pick-up position symbol 221 that represents a pinpoint pick-up position is displayed at a prescribed position in the area AR of attention and a number-of-pick-ups display 222 that displays a predicted number of pick-ups at the pinpoint pick-up position symbol 221 is displayed. In FIG. 15, “43” displayed in the area-of-attention frame 211 represents the number of pick-ups for the entire area AR of attention and, among the “43”, the number-of-pick-ups display 222 of “29” represents the number of pick-ups at a pinpoint pick-up position “Shinagawa Station Takanawa Exit Taxi Stand” denoted by the pinpoint pick-up position symbol 221. In this manner, by displaying a pinpoint pick-up position and the number of pick-ups that is predicted at the pinpoint pick-up position in addition to the number of pick-ups of the area AR of attention, a ratio of hires can be increased.

A pinpoint pick-up position can be estimated by learning using hired vehicle data instead of individually studying locations with fixed pick-up positions in the area AR.

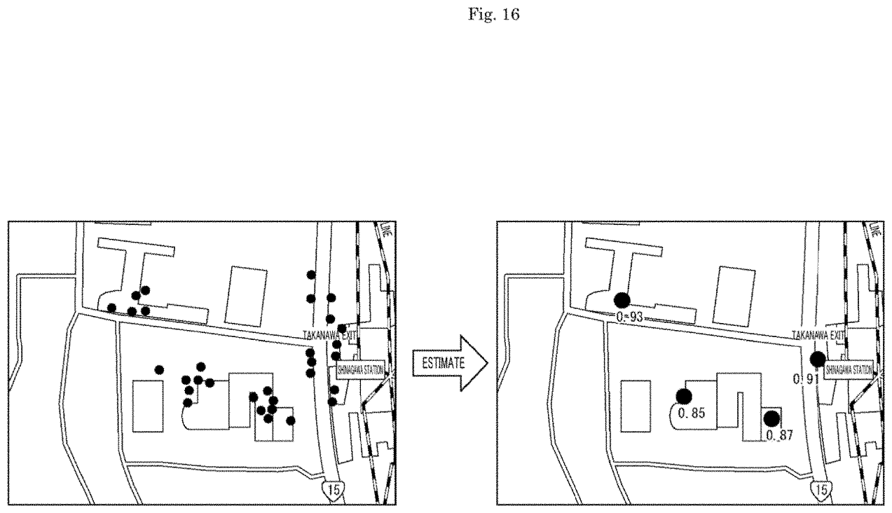

Specifically, as indicated by black dots on a left side of FIG. 16, previous pick-up positions of passengers can be identified from information on a point of origin of hired vehicle data. By learning previous pick-up positions of passengers, as shown on a right side of FIG. 16, estimated values of pick-up positions indicated by black dots and probabilities (likelihoods) of the pick-up positions are calculated. The probability of a pick-up position is represented by a numeral ranging from 0 to 1 which is displayed in a vicinity of the pick-up position in FIG. 16. For example, the demand prediction application can display an estimated value of a pick-up position of which a probability as a pick-up position is equal to or higher than a prescribed threshold (for example, 0.8) as a pinpoint pick-up position in the area AR of attention.

<10. Display of Prediction of Queueing Time>

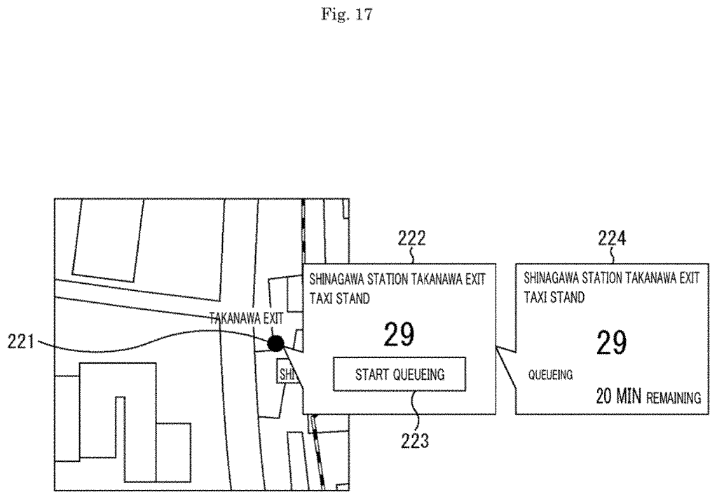

FIG. 17 shows a fourth display example of the demand prediction screen that is displayed by the demand prediction application.

FIG. 17 also shows a display example of displaying a further detailed prediction result when the driver selects a prescribed area AR as the area AR of attention.

At locations which have a fixed pick-up position and which have a larger number of pick-ups such as a taxi stand in front of a station and a taxi stand in front of a hotel, there is a method called “queueing” in which a taxi 11 acquires a passenger by standing by in a queue formed by taxis 11 waiting for passengers at a pick-up position. A disadvantage of queueing is that, for example, when a long queue of taxis 11 has already been formed at a taxi stand, a taxi 11 must wait for a long time to pick up a passenger after lining up at the end of the long queue of taxis 11.

In consideration thereof, when queueing is performed at a pick-up position (a pinpoint pick-up position) with a large number of pick-ups, the demand prediction application can display a time required for queueing or, in other words, a time required to pick up a passenger while waiting at the pick-up position.

Specifically, as shown in FIG. 17, when the pinpoint pick-up position symbol 221 in the area AR of attention is a queueing location, the demand prediction application causes a queueing start button 223 to be displayed in the number-of-pick-ups display 222 at the pinpoint pick-up position symbol 221. When the queueing start button 223 is tapped (touched), the demand prediction application displays a queueing display 224 that indicates a time (a queueing time) required by queueing when the queueing is performed. In the example shown in FIG. 17, “20 minutes” is displayed as the queueing time.

For example, by causing the queueing display 224 to be displayed at the pinpoint pick-up position, the driver can check the queueing time and select a location where queueing is to be performed. The queueing time to be displayed by the queueing display 224 may be a value given a certain leeway such as “15 minutes to 20 minutes”.

In vehicle dynamic log data, since a pick-up change point where the status changes from “for hire” to “hired” and a state in which the taxi 11 is moving slowly shortly before the pick-up change point can be detected, a queueing operation of the taxi 11 can also be detected. For example, travel at or below a prescribed speed (at or below 5 km/h) in a prescribed period prior to the time point of the pick-up change point or within a prescribed distance can be detected as a queueing operation. Therefore, by learning a queueing operation, a queueing time at a prescribed pick-up position can be predicted.

<11. Display of Prediction of Degree of Long Distance>

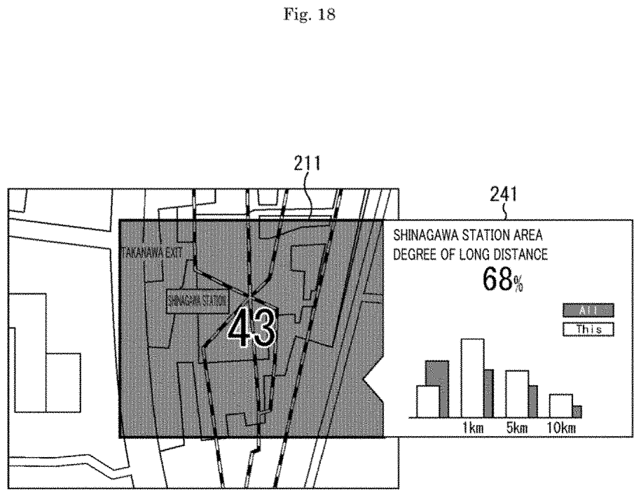

FIG. 18 shows a fifth display example of the demand prediction screen that is displayed by the demand prediction application.

FIG. 18 also shows a display example of displaying a further detailed prediction result when the driver selects a prescribed area AR as the area AR of attention.

For example, areas AR created by dividing the business region into prescribed units may include areas AR or pick-up positions with a high ratio of pick-ups that involve long ride distances (a prescribed distance or longer) such as when the destination is Haneda Airport or Narita Airport. Preferably, the driver is capable of determining the possibility of long-distance passengers.

In consideration thereof, as shown in FIG. 18, the demand prediction application can perform a long-distance display 241 that displays a ratio of long-distance passengers in the area AR of attention separately from a total number of pick-ups in the area AR of attention.

In long-distance display 241, a ratio (proportion) of pick-ups of which a ride distance is a long distance to the total number of pick-ups of the area AR of attention is displayed as a degree of long distance. In addition, in long-distance display 241, ride distances are divided into a plurality of classifications and a ratio of pick-ups for each divided classification is displayed by a bar graph as a classification of long distance. In FIG. 18, bar graphs labeled “All” indicate a ratio of pick-ups for each classification to the entire business region and bar graphs labeled “This” indicate a ratio of pick-ups for each classification of an area AR of attention.

The long-distance display 241 may display a degree of long distance and a classification of long distance with respect to the area AR of attention as shown in FIG. 18 or display a degree of long distance and a classification of long distance in association with the pinpoint pick-up position symbol 221 and display a degree of long distance and a classification of long distance with respect to a pinpoint pick-up position.

While the bar graphs of the long-distance display 241 shown in FIG. 18 divide ride distances into a plurality of classifications as classifications of long distance and indicate a ratio of pick-ups for each divided classification (ride distance), alternatively, fares may be divided into a plurality of classifications and a ratio of pick-ups for each divided classification (fare) may be indicated.

In addition, the long-distance display 241 may predict a pick-up demand for each time slot or each type of weather and display a degree of long distance or a classification of long distance that is customized for a prescribed time slot or a prescribed type of weather.

A degree of long distance and a classification of long distance can be predicted by performing learning so as to also include the items of ride distance and fare of hired vehicle data.

<12. Display of Prediction of Ride Distance>

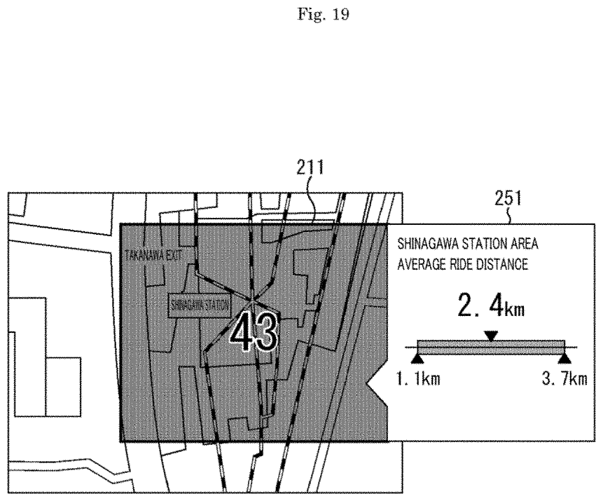

FIG. 19 shows a sixth display example of the demand prediction screen that is displayed by the demand prediction application.

FIG. 19 also shows a display example of displaying a further detailed prediction result when the driver selects a prescribed area AR as the area AR of attention.

As shown in FIG. 19, when a prescribed area AR is selected as the area AR of attention, the demand prediction application can perform ride distance display 251 that displays an average ride distance and a confidence interval thereof of passengers who are picked up in the area AR of attention. The confidence interval represents a range in which an average value of a population (a population average) is included with prescribed reliability.

In the ride distance display 251, it is displayed that the average ride distance of pick-ups in the area AR of attention is “2.4 km” and a confidence interval of the average ride distance at, for example, 95%-reliability is “1.1 km to 3.7 km”. The reliability of the confidence interval is not limited to 95% and can be arbitrarily set to 99% or the like.

In this manner, by displaying an average ride distance and a confidence interval thereof of the area AR of attention, for example, the driver can search for an area AR with a ride distance suitable for remaining on-duty time or search for an area AR with a long ride distance as a “cruising” path.

The ride distance display 251 may display an average ride distance and a confidence interval with respect to the area AR of attention as shown in FIG. 19 or display an average ride distance and a confidence interval in association with the pinpoint pick-up position symbol 221 and display an average ride distance and a confidence interval with respect to a pinpoint pick-up position.

Alternatively, an average fare (fee) and a confidence interval may be displayed instead of an average ride distance and a confidence interval.

Yet alternatively, an average ride duration and a confidence interval may be displayed instead of an average ride distance and a confidence interval.

In addition, the ride distance display 251 may predict a pick-up demand for each time slot or each type of weather and display an average ride distance and a confidence interval, an average fare and a confidence interval, or an average ride duration and a confidence interval that are customized for a prescribed time slot or a prescribed type of weather.

<13. Display of Prediction of Fare>

There are users who refrain from using taxis 11 since fares are only finalized after being picked up. The demand prediction application has a function of predicting a fare from a current location and a destination and displaying the predicted fare.

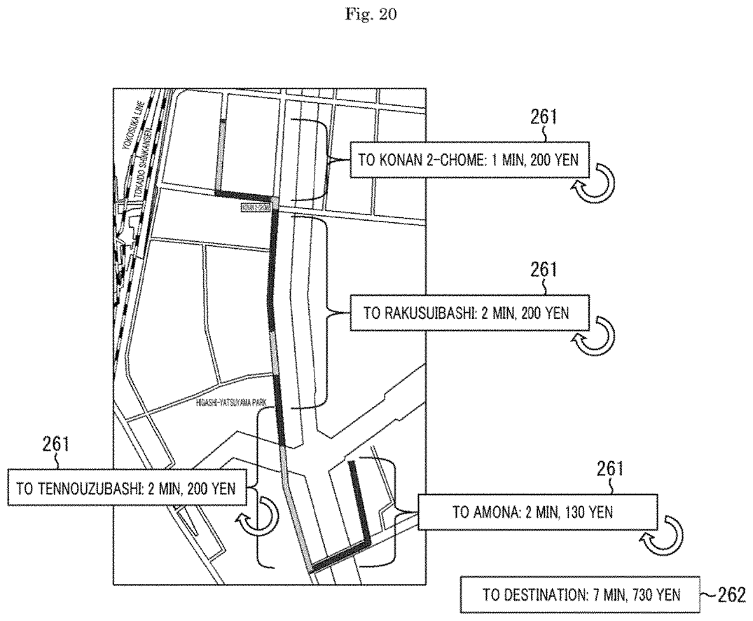

FIG. 20 shows an example of a fare prediction screen that is displayed by the demand prediction application.

The demand prediction application causes a time and a fare required to move to a destination to be displayed on a display as a prediction result and, at the same time, causes a time and a fare required by the movement for each division unit created by dividing a movement path to the destination into prescribed units to be displayed on the display as a prediction result.

On the fare prediction screen shown in FIG. 20, an individual display 261 indicates a time and a fare required by movement for each division unit. A destination display 262 indicates a time and a fare required by the movement to the destination.

Learning of a fare and a movement time is difficult when using the hired vehicle data shown in FIG. 5 without modification because both a point of origin and a point of arrival require the same data. In consideration thereof, the control portion 121 learns a time and a fare required by movement for each divided unit from the vehicle dynamic log data. In addition, by obtaining a sum of times and fares of the respective divided units included from the point of origin to the point of arrival, the control portion 121 calculates a time and a fare required to move to the destination. For example, the division unit can be a unit divided using at least one or a plurality of a unit divided by a prescribed distance, a prescribed time, a road section (block), or the like, a unit divided by traffic lights or intersections, and the like.

A movement time and a fare for each divided unit and a movement time and a fare to the destination may be displayed with a prescribed leeway such as “5 minutes to 10 minutes” and “300 yen to 500 yen”.

According to the various display methods described with reference to FIGS. 13 to 20, the driver of the taxi 11 can provide services in a more efficient manner. In other words, the demand prediction application can present a prediction result that contributes toward improving a pick-up ratio.

With respect to the various display methods described with reference to FIGS. 13 to 20, enabling or disabling display, an order of displays, and the like can be appropriately set on a setting screen that is displayed on the display when the driver operates the setting button 64 of the demand prediction application.

<14. Learning of Pick-Up Position>

Next, learning and predictions other than those related to a pick-up demand which are performed by the server 12 will be explained.

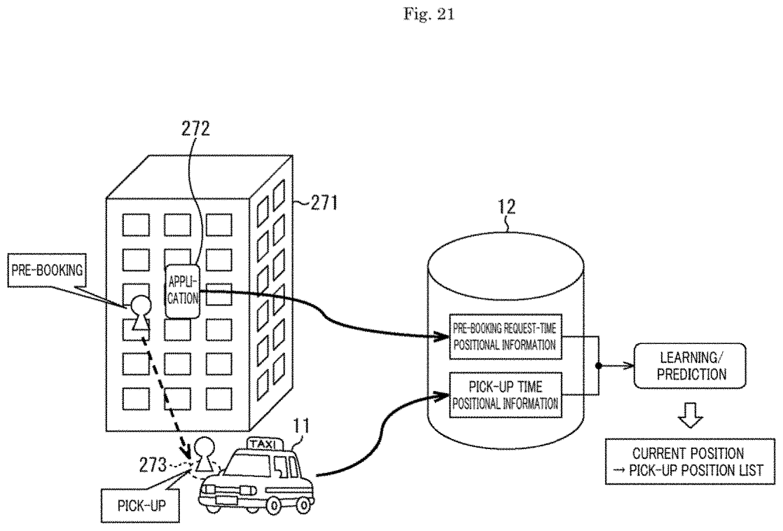

FIG. 21 is a diagram for explaining learning of a pick-up position with respect to a building.

For example, a user (customer) of the taxi 11 books the taxi 11 using a pre-booking application 272 executed on a terminal such as a smartphone from a prescribed position inside a building 271 and gets on the taxi 11 at a prescribed position 273 such as a driveway of the building 271. In this case, the pre-booking application 272 acquires positional information of the user at a timing at which the user had booked the taxi 11 from a GPS receiver inside the terminal and transmits the positional information to the server 12 as pre-booking request-time positional information. In addition, pick-up time positional information that is positional information of the user at a timing at which the user had got onto the taxi 11 can be acquired from the vehicle dynamic log data that is transmitted from the vehicle management apparatus 22 of the taxi 11.

The server 12 learns a relationship between the pre-booking request-time positional information and the pick-up time positional information. Accordingly, a pick-up position at the building 271 can be learned in terms of where the driver should position the taxi 11 relative to the building 271 when the user books the taxi 11 from a prescribed position inside the building 271. The server 12 stores a learning result in the storage portion 122 as a pick-up position list. The demand prediction application can display a learned pick-up position at the building 271 on the map 41. In addition, when the user designates the building 271 as a destination, the driver can adopt the learned pick-up position at the building 271 as a drop-off position.

Furthermore, even with respect to buildings other than the building 271 at which the taxi 11 had actually been booked, the server 12 can infer a pick-up position at the buildings based on a learned relationship between the pre-booking request-time positional information and the pick-up time positional information and display the inferred pick-up position on the map 41.

<15. Learning of Drop-Off Position>

FIG. 21 is a diagram for explaining learning of a drop-off position with respect to a building.

For example, a user is dropped off by the taxi 11 at a prescribed position 274 and moves to the prescribed building 271 that is a destination. Drop-off time positional information that is positional information of the user at a timing at which the user had been dropped off by the taxi 11 can be acquired from the vehicle dynamic log data that is transmitted from the vehicle management apparatus 22 of the taxi 11. In addition, the pre-booking application 272 acquires positional information of the building 271 to which the user had moved after being dropped off by the taxi 11 from the GPS receiver inside the terminal and transmits the positional information to the server 12 as post-movement positional information.

The server 12 learns a relationship between the drop-off time positional information and the post-movement positional information. Accordingly, a drop-off position at the building 271 can be learned in terms of where the driver should drop off a user when the user designates the building 271 as a destination. The server 12 stores a learning result in the storage portion 122 as a drop-off position list. The demand prediction application can display a learned drop-off position at the building 271 on the map 41. In addition, when the user books the taxi 11 using the pre-booking application 272 from a prescribed position inside the building 271, the driver can also utilize the learned drop-off position at the building 271 as a pick-up position.

<16. Learning of Pick-Up Position>

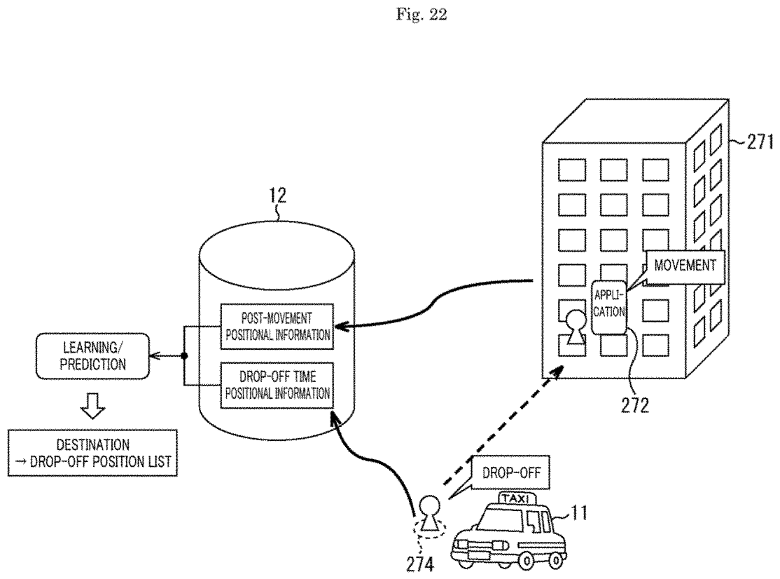

While the examples explained with reference to FIGS. 21 and 22 include also displaying a learned pick-up position as a drop-off position and also displaying a learned drop-off position as a pick-up position, generally, a pick-up position and a drop-off position with respect to a building are often situated in a taxi pool or a driveway, in front of an entrance, or the like and are often the same position or positions that are close to each other.

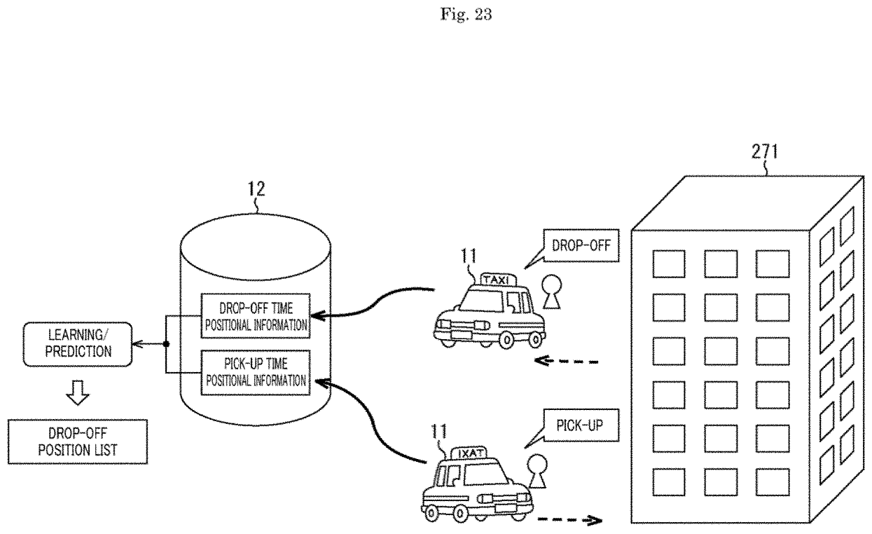

In consideration thereof, as shown in FIG. 23, the server 12 learns pick-up time positional information and drop-off time positional information, learns an optimal pick-up position for the building 271, and stores the learned optimal pick-up position in the storage portion 122 as a pick-up position list. The demand prediction application can display a learned pick-up position at the building 271 on the map 41.

<17. Configuration Example of Computer>

The series of processing described above can be executed by hardware or by software. When the series of processing is to be executed by software, a program constituting the software is installed in a computer. Examples of the computer in this case include a microcomputer that is built into dedicated hardware and a general-purpose personal computer or the like capable of executing various functions when various programs are installed therein.

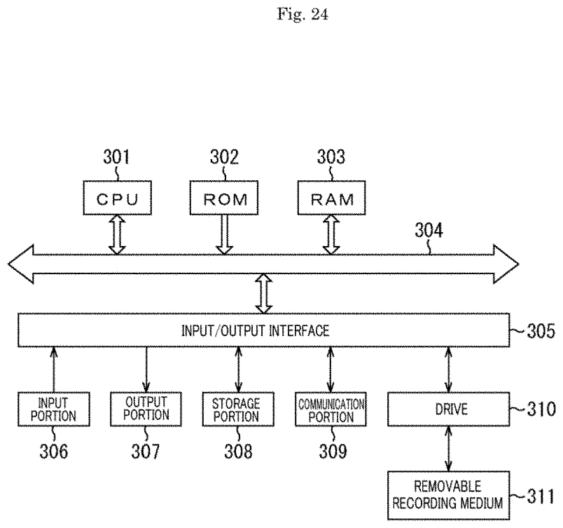

FIG. 24 is a block diagram showing a configuration example of hardware of a computer in a case where the computer executes, using a program, the respective processing steps to be executed by the server 12, the vehicle management apparatus 22, or the terminal apparatus 23.

In the computer, a CPU (Central Processing Unit) 301, a ROM (Read Only Memory) 302, and a RAM (Random Access Memory) 303 are connected to each other by a bus 304.

An input/output interface 305 is further connected to the bus 304. An input portion 306, an output portion 307, a storage portion 308, a communication portion 309, and a drive 310 are connected to the input/output interface 305.

The input portion 306 is constituted by an operating button, a keyboard, a mouse, a microphone, a touch panel, an input terminal, or the like. The output portion 307 is constituted by a display, a speaker, an output terminal, or the like. The storage portion 308 is constituted by a hard disk, a RAM disk, a non-volatile memory, or the like. The communication portion 309 is constituted by a network interface or the like. The drive 310 drives a removable recording medium 311 that is a magnetic disk, an optical disk, a magneto optical disk, a semiconductor memory, or the like.

In the computer configured as described above, the series of processing described earlier is performed as the CPU 301 loads a program stored in the storage portion 308 onto the RAM 303 via the input/output interface 305 and the bus 304 and executes the program. Data required by the CPU 301 to execute the various types of processing is also stored in the RAM 303 when appropriate.

For example, the program executed by the computer (the CPU 301) can be provided by being recorded on the removable recording medium 311 as a packaged medium or the like. Alternatively, the program can be provided via a wired or wireless transmission medium such as a local area network, the Internet, or digital satellite broadcasting.

In the computer, the program can be installed in the storage portion 308 via the input/output interface 305 by mounting the removable recording medium 311 to the drive 310. In addition, the program can be received by the communication portion 309 via a wired or wireless transmission medium and installed in the storage portion 308. Alternatively, the program can be installed in the ROM 302 or the storage portion 308 in advance.

In the present specification, a system signifies a set of a plurality of components (apparatuses, modules (parts), and the like), and whether or not all of the components are present inside a same casing does not matter. Therefore, a plurality of apparatuses which are housed in separate casings but which are connected to each other via a network and a single apparatus in which a plurality of modules are housed in a single casing are both considered systems.

In addition, in the present specification, in addition to cases where the steps described in the flow charts are time-sequentially performed in the described orders, the steps need not necessarily be processed in a time-sequential manner and may be executed in parallel or at necessary timings such as when a call is performed.

Embodiments of the present technique are not limited to the embodiment described above and various modifications can be made without departing from the gist of the present technique.

While an example of a prediction system that predicts demands for a pick-up by a taxi as a business vehicle has been explained in the embodiment described above, the embodiment can also be applied to systems that predict demands for other business vehicles that carry passengers (people) such as buses, trains, airplanes, ocean vessels, and helicopters as well as business vehicles that carry goods (cargo) such as trucks and dump trucks. Alternatively, the business vehicle may be a transport vehicle that operates in an unmanned manner such as a drone.

A mode that combines all of or a part of the embodiment described above as appropriate can be adopted.

For example, the present technique may adopt a configuration of cloud computing in which a single function is shared among and cooperatively processed by a plurality of apparatuses via a network.

In addition, each step explained in the flow charts described above can be executed in a shared manner by a plurality of apparatuses in addition to being executed by a single apparatus.

Furthermore, when a single step includes a plurality of processing steps, the plurality of processing steps included in the single step can be executed in a shared manner by a plurality of apparatuses in addition to being executed by a single apparatus.

It should be noted that the advantageous effects described in the present specification are merely exemplary and are not restrictive, and advantageous effects other than those described in the present specification may be produced.

The present technique can also be configured as follows.

(1)

An information processing apparatus, including:

a control portion configured to divide a business region into a plurality areas and, using hired vehicle sequence data that is data for each area indicating that a business vehicle has picked up a customer, execute first clustering in which the plurality of areas are clustered using a first parameter and execute second clustering in which the plurality of areas are clustered using a second parameter.

(2)

The information processing apparatus according to (1), wherein the hired vehicle sequence data represents the number of pick-ups for each prescribed time interval in the area.

(3)

The information processing apparatus according to (1) or (2), wherein the first parameter is an average and a dispersion of a number of pick-ups per unit time in the area, and the second parameter is a waveform of an average number of pick-ups per unit time in the area.

(4)

The information processing apparatus according to (3), wherein the first parameter is an average and a dispersion of the number of pick-ups per unit time on a prescribed day of the week in the area, and the second parameter is a waveform of an average number of pick-ups per unit time on a prescribed day of the week in the area.

(5)

The information processing apparatus according to (3), wherein the first parameter is an average and a dispersion of the number of pick-ups per unit time on a weekday or a holiday in the area, and the second parameter is a waveform of an average number of pick-ups per unit time on a weekday or a holiday in the area.

(6)

The information processing apparatus according to any one of (1) to (5), wherein the control portion is configured to extract a prescribed number of areas from all areas corresponding to the business region as representative areas, and execute the first clustering and the second clustering using the hired vehicle sequence data of the extracted representative areas.

(7)

The information processing apparatus according to (6), wherein the control portion is configured to execute clustering of unknown areas being the areas other than the representative area using a classifier generated by learning a relationship between a result of clustering of the representative areas and the hired vehicle sequence data of the representative areas.

(8)

The information processing apparatus according to (7), wherein the control portion is configured to predict a pick-up demand of the unknown areas using a predictor of a same cluster as the result of clustering of the unknown areas.

(9)

The information processing apparatus according to any one of (1) to (8), wherein the control portion is configured to generate by learning, using hired vehicle sequence data of one or more of the areas belonging to a prescribed cluster, a predictor for predicting a pick-up demand of the area belonging to the prescribed cluster, and predict a pick-up demand of the area using the generated predictor.

(10)

The information processing apparatus according to any one of (1) to (9), wherein the control portion is configured to learn a pick-up position from pre-booking request-time positional information that represents a position where the customer had requested pre-booking of the business vehicle and pick-up time positional information that represents a position where the customer had got onto the pre-booked business vehicle.

(11)

The information processing apparatus according to any one of (1) to (10), wherein the control portion is configured to learn a drop-off position from drop-off time positional information that represents a position where the customer had got off the business vehicle and post-movement positional information that represents a position where the customer had moved after getting off the business vehicle.

(12)

The information processing apparatus according to any one of (1) to (11), wherein the control portion is configured to learn a pick-up position from drop-off time positional information that represents a position where the customer had got off the business vehicle and pick-up time positional information that represents a position where the customer had got onto the business vehicle.

(13)

An information processing method, including:

an information processing apparatus

dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.

(14)

A program for causing a computer to execute processing for:

dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.

### REFERENCE SIGNS LIST

1 Prediction system
11 Taxi
12 Server
22 Vehicle management apparatus
23 Terminal apparatus
63 Demand prediction mesh
121 Control portion
131 Data generating portion
132 Learning portion
133 Predicting portion
141 Control portion
142 Operating portion
143 Display portion
211 Area-of-attention frame
212 Arrow
221 Pinpoint pick-up position symbol
222 Number-of-pick-ups display
223 Queueing start button
224 Queueing display
241 Long-distance display
251 Ride distance display
261 Individual display
262 Destination display
301 CPU
302 ROM
303 RAM
306 Input portion
307 Output portion
1308 Storage portion
309 Communication portion
310 Drive

1. An information processing apparatus, comprising:
a control portion configured to divide a business region into a plurality areas and, using hired vehicle sequence data that is data for each area indicating that a business vehicle has picked up a customer, execute first clustering in which the plurality of areas are clustered using a first parameter and execute second clustering in which the plurality of areas are clustered using a second parameter.

2. The information processing apparatus according to claim 1, wherein
the hired vehicle sequence data represents the number of pick-ups for each prescribed time interval in the area.

3. The information processing apparatus according to claim 1, wherein
the first parameter is an average and a dispersion of a number of pick-ups per unit time in the area, and the second parameter is a waveform of an average number of pick-ups per unit time in the area.

4. The information processing apparatus according to claim 3, wherein
the first parameter is an average and a dispersion of the number of pick-ups per unit time on a prescribed day of the week in the area, and the second parameter is a waveform of an average number of pick-ups per unit time on a prescribed day of the week in the area.

5. The information processing apparatus according to claim 3, wherein
the first parameter is an average and a dispersion of the number of pick-ups per unit time on a weekday or a holiday in the area, and the second parameter is a waveform of an average number of pick-ups per unit time on a weekday or a holiday in the area.

6. The information processing apparatus according to claim 1, wherein
the control portion is configured to extract a prescribed number of areas from all areas corresponding to the business region as representative areas, and execute the first clustering and the second clustering using the hired vehicle sequence data of the extracted representative areas.

7. The information processing apparatus according to claim 6, wherein
the control portion is configured to execute clustering of unknown areas being the areas other than the representative area using a classifier generated by learning a relationship between a result of clustering of the representative areas and the hired vehicle sequence data of the representative areas.

8. The information processing apparatus according to claim 7, wherein
the control portion is configured to predict a pick-up demand of the unknown areas using a predictor of a same cluster as the result of clustering of the unknown areas.

9. The information processing apparatus according to claim 1, wherein
the control portion is configured to generate by learning, using hired vehicle sequence data of one or more of the areas belonging to a prescribed cluster, a predictor for predicting a pick-up demand of the area belonging to the prescribed cluster, and predict a pick-up demand of the area using the generated predictor.

10. The information processing apparatus according to claim 1, wherein
the control portion is configured to learn a pick-up position from pre-booking request-time positional information that represents a position where the customer had requested pre-booking of the business vehicle and pick-up time positional information that represents a position where the customer had got onto the pre-booked business vehicle.

11. The information processing apparatus according to claim 1, wherein
the control portion is configured to learn a drop-off position from drop-off time positional information that represents a position where the customer had got off the business vehicle and post-movement positional information that represents a position where the customer had moved after getting off the business vehicle.

12. The information processing apparatus according to claim 1, wherein
the control portion is configured to learn a pick-up position from drop-off time positional information that represents a position where the customer had got off the business vehicle and pick-up time positional information that represents a position where the customer had got onto the business vehicle.

13. An information processing method, comprising:
by an information processing apparatus,
dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.

14. A program for causing a computer to execute processing for:
dividing a business region into a plurality areas and, using hired vehicle sequence data that is data for each area indicating that a business vehicle has picked up a customer, executing first clustering in which the plurality of areas are clustered using a first parameter and executing second clustering in which the plurality of areas are clustered using a second parameter.
